(19) United States
(12) Patent Application Publication
(10) Pub. No.: US 2024/0166891 A1
(43) Pub. Date: May 23, 2024

(54) FLEXIBLE POLYMER ELECTROPHORETIC COATING AND USE THEREOF IN PREPARATION OF GARDEN SHEARS

(71) Applicant: Zhongshan Green Guard Metal Production Co., Ltd.,, Zhongshan (CN)

(72) Inventors: Mike MA, Zhongshan (CN); Jiachang XU, Zhongshan (CN)

(21) Appl. No.: 18/474,330

(22) Filed: Sep. 26, 2023

(30) Foreign Application Priority Data
Nov. 23, 2022 (CN) 202211472226.2

(51) Int. Cl. C09D 5/44; C09D 5/02; C09D 7/61; C09D 7/63

(52) U.S. Cl. CPC C09D 5/4434; C09D 5/022; C09D 7/61; C09D 7/63; A01G 3/02

(57) ABSTRACT

Disclosed is a flexible polymer electrophoretic coating, including an emulsion and a color paste, where the emulsion includes the following raw materials in parts by weight: 20-40 parts of an epoxy resin; 1-5 parts of ethanolamine; 1-5 parts of propylene glycol methyl ether acetate; 0.1-1 parts of propylene glycol phenyl ether; 2-3 parts of lactic acid; and 50-70 parts of water; the color paste includes the following raw materials in parts by weight: 5-10 parts of an epoxy resin; 0.1-1 parts of ethanolamine; 1-3 parts of propylene glycol methyl ether acetate; 0.05-0.3 parts of propylene glycol phenyl ether; 0.5-2 parts of lactic acid; and 0.1-1 parts of a colorant; and a weight ratio of the emulsion to the color paste is (1-2):1. The flexible polymer electrophoretic coating can effectively improve the abrasion resistance of the surface of the garden shears and reduces the occurrence of peeling off.

### CROSS-REFERENCE TO RELATED APPLICATION

This application is filed on the basis of Chinese patent application No. 202211472226.2 filed Nov. 23, 2022, and claims priority of the Chinese patent application, the entire contents of which are incorporated herein by reference.

### TECHNICAL FIELD

The present disclosure belongs to the technical field of cutting tool processing, and in particular to a flexible polymer electrophoretic coating and use thereof in the preparation of garden shears.

### BACKGROUND

With the continuous improvement of people's quality of life, more and more people are involved in the activity of gardening pruning. Garden shears are tools commonly used by people in gardening pruning. Most of the existing garden shears have a layer of Teflon paint sprayed on the surface of the shears. However, the Teflon paint on the surface is prone to abrasion, peeling, and the like during frequent use of the garden shears, resulting in a decline in the anti-rust function of the shears, which cannot meet people's normal use requirements.

### SUMMARY

The present disclosure is intended to solve at least one of the technical problems existed in the existing technology. To this end, the present disclosure proposes a flexible polymer electrophoretic coating and use thereof in the preparation of garden shears. The application of the flexible polymer electrophoretic coating to the garden shears through electrophoretic painting can effectively improve the abrasion resistance of the surface of the garden shears and reduces the occurrence of peeling off, thereby improving the anti-rust performance of the shears and ensuring normal use.

The aforementioned technical objective of the present disclosure is realized through the following technical scheme.

A flexible polymer electrophoretic coating including an emulsion and a color paste is provided, wherein the emulsion includes the following raw materials in parts by weight: 20-40 parts of an epoxy resin; 1-5 parts of ethanolamine; 1-5 parts of propylene glycol methyl ether acetate; 0.1-1 parts of propylene glycol phenyl ether; 2-3 parts of lactic acid; and 50-70 parts of water; the color paste includes the following raw materials in parts by weight: 5-10 parts of an epoxy resin; 0.1-1 parts of ethanolamine; 1-3 parts of propylene glycol methyl ether acetate; 0.05-0.3 parts of propylene glycol phenyl ether; 0.5-2 parts of lactic acid; and 0.1-1 parts of a colorant; and a weight ratio of the emulsion to the color paste is (1-2):1.

Preferably, the ethanolamine is monoethanolamine.

Preferably, the colorant is carbon black.

A method for preparing the flexible polymer electrophoretic coating as described above includes the following steps:
(1) preparation of an emulsion: mixing an epoxy resin, ethanolamine, propylene glycol methyl ether acetate, propylene glycol phenyl ether and lactic acid at a formulated amount at 60-70° C. and conducting heat-preservation under stirring for 2-3 h, and then adding a formulated amount of water and stirring for 1-2 h, to obtain the emulsion;
(2) preparation of a color paste: mixing an epoxy resin, ethanolamine, propylene glycol methyl ether acetate, propylene glycol phenyl ether and lactic acid at a formulated amount at 50-60° ° C. and conducting heat-preservation under stirring for 2-3 h, then adding a formulated amount of a colorant, and grinding to obtain the color paste; and
(3) mixing the emulsion prepared in the step (1) with the color paste prepared in the step (2) in proportion to obtain the flexible polymer electrophoretic coating.

A method for preparing a garden shear includes the following steps:
(1) demagnetizing and cleaning a shear blank;
(2) subjecting the shear obtained in the step (1) to electrophoretic painting, wherein an electrophoretic coating used in the electrophoretic painting includes the flexible polymer electrophoretic coating as described above; and
(3) cleaning the shear obtained in the step (2), and then baking and cooling to obtain a finished garden shear.

Preferably, the shear obtained in the step (1) is subjected to soaking treatment in a coating solution before the electrophoretic painting, and the coating solution comprises the following raw materials in parts by weight: 30-40 parts of phosphoric acid; 10-20 parts of citric acid; 10-20 parts of zinc oxide; 3-4 parts of 2,3-dihydrobutanedioic acid; 1-2 parts of iron nitrate nonahydrate; 1-2 parts of nickel nitrate hexahydrate; and 25-30 parts of water.

Preferably, the soaking treatment is conducted in the coating solution for a duration of 5-10 minutes.

Preferably, in the step (2), the electrophoretic painting is conducted at a voltage of 100-120 V and a temperature of 15-35° C.

Preferably, in the step (2), the electrophoretic painting is conducted for a duration of 60-90 seconds.

Preferably, in the step (3), the baking is conducted at a temperature of 260-270° C. for a duration of 30-40 min.

Preferably, a method for preparing a garden shear includes the following steps:
1) demagnetizing a shear blank and hanging the same onto a hanger to obtain a hanger product;
2) cleaning the hanger product by an ultrasonic wave to degrease and remove surface impurities;
3) introducing the hanger product into a coating tank containing a coating solution and soaking the hanger product in the coating solution at room temperature for 7 minutes;
4) passing the hanger product through a first showerhead for spraying with pure water for 4 minutes and 10 seconds;
5) introducing the hanger product into a pure water tank and soaking the hanger product in pure water for 1 minute and 20 seconds;
6) passing the hanger product through a second showerhead for spraying with pure water for 2 minutes and 48 seconds;
7) introducing the hanger product into an electrophoresis tank to undergo electrophoresis in the electrophoretic coating as described above, wherein the electrophoresis is conducted at a voltage of 100-120 V for a duration of 60-90 seconds;
8) passing the hanger product through a third showerhead and a fourth showerhead for spraying for a duration of 5 minutes and 51 seconds;
9) placing the hanger product into an oven for baking at a temperature of 260-270° ° C. for a duration of 30-40 minutes; and
10) removing the hanger product from the oven and passing the same through a cooling zone for cooling down to obtain a finished product (the garden shear).

The beneficial effects of the present disclosure are as follows.

(1) The flexible polymer electrophoretic coating of the present disclosure can form an anti-rust layer on the surface of the shear blades after being applied to the garden shears through electrophoretic painting, which effectively prevents the erosion by the air and the water in the air, so as to achieve the purpose of rust prevention.

(2) The flexible polymer electrophoretic coating of the present disclosure has strong adhesion to the surface of the shear blades after being applied to the garden shears through electrophoretic painting, and the paint film on the surface of the shear blades is less prone to abrasion and peeling off during the use of the shears, which can effectively enhance the abrasion resistance and prolong the service life of the shears.

### DETAILED DESCRIPTION

The present disclosure will be further described below with reference to specific examples.

### Example 1

A flexible polymer electrophoretic coating including an emulsion and a color paste was provided, wherein the emulsion included the following raw materials in parts by weight: 20 parts of an epoxy resin; 1 part of monoethanolamine; 1 part of propylene glycol methyl ether acetate; 0.1 parts of propylene glycol phenyl ether; 2 parts of lactic acid; and 50 parts of water; the color paste included the following raw materials in parts by weight: 5 parts of an epoxy resin; 0.1 parts of monoethanolamine; 1 part of propylene glycol methyl ether acetate; 0.05 parts of propylene glycol phenyl ether; 0.5 parts of lactic acid; and 0.1 parts of carbon black; and a weight ratio of the emulsion to the color paste was 1:1.

A method for preparing the aforementioned flexible polymer electrophoretic coating, included the following steps:
(1) preparation of an emulsion: mixing an epoxy resin, monoethanolamine, propylene glycol methyl ether acetate, propylene glycol phenyl ether and lactic acid according to the above formulated amount at 60° C. and conducting heat-preservation under stirring for 2 h, and then adding water according to the above formulated amount and stirring for 1 h, to obtain the emulsion;
(2) preparation of a color paste: mixing an epoxy resin, monoethanolamine, propylene glycol methyl ether acetate, propylene glycol phenyl ether and lactic acid according to the above formulated amount at 50° C. and conducting heat-preservation under stirring for 2 h, then adding carbon black according to the above formulated amount, and grinding to obtain the color paste; and
(3) mixing the emulsion prepared in the step (1) with the color paste prepared in the step (2) according to the above ratio to obtain the flexible polymer electrophoretic coating.

A method for preparing a garden shear included the following steps:
1) demagnetizing a shear blank and hanging the same onto a hanger, to obtain a hanger product;
2) cleaning the hanger product by an ultrasonic wave to degrease and remove surface impurities;
3) introducing the hanger product into a coating tank containing a coating solution and soaking the hanger product in the coating solution at room temperature for 5 minutes, wherein the coating solution included the following raw materials in parts by weight: 30 parts of phosphoric acid; 10 parts of citric acid; 10 parts of zinc oxide; 3 parts of 2,3-dihydrobutanedioic acid; 1 part of iron nitrate nonahydrate; 1 part of nickel nitrate hexahydrate; and 25 parts of water;
4) passing the hanger product through a first showerhead for spraying with pure water for 3 minutes and 10 seconds;
5) introducing the hanger product into a pure water tank and soaking the hanger product in pure water for 1 minute and 20 seconds;
6) passing the hanger product through a second showerhead for spraying with pure water for 2 minutes and 48 seconds;
7) introducing the hanger product into an electrophoresis tank to undergo electrophoresis in the electrophoretic coating as described above, wherein the electrophoresis was conducted at a voltage of 100 V and a temperature of 25° C. for a duration of 60 seconds;
8) passing the hanger product through a third showerhead and a fourth showerhead for spraying for a time of 5 minutes and 51 seconds;
9) placing the hanger product into an oven for baking at a temperature of 260° C. for a duration of 30 minutes; and
10) removing the hanger product from the oven and passing the same through a cooling zone for cooling down to obtain the garden shear.

The aforementioned hanger product ran at a linear speed of 22 m/s, and the production processes were all operated under normal pressure.

### Example 2

A flexible polymer electrophoretic coating including an emulsion and a color paste was provided, wherein the emulsion included the following raw materials in parts by weight: 40 parts of an epoxy resin; 5 parts of monoethanolamine; 5 parts of propylene glycol methyl ether acetate; 1 part of propylene glycol phenyl ether; 3 parts of lactic acid; and 70 parts of water; the color paste included the following raw materials in parts by weight: 10 parts of an epoxy resin; 1 part of monoethanolamine; 3 parts of propylene glycol methyl ether acetate; 0.3 parts of propylene glycol phenyl ether; 2 parts of lactic acid; and 1 part of carbon black; and a weight ratio of the emulsion to the color paste was 2:1.

A method for preparing the aforementioned flexible polymer electrophoretic coating included the following steps:
(1) preparation of an emulsion: mixing an epoxy resin, monoethanolamine, propylene glycol methyl ether acetate, propylene glycol phenyl ether and lactic acid according to the above formulated amount at 70° C. and conducting heat-preservation under stirring for 3 h, and then adding water according to the above formulated amount and stirring for 1-2 h, to obtain the emulsion;
(2) preparation of a color paste: mixing an epoxy resin, monoethanolamine, propylene glycol methyl ether acetate, propylene glycol phenyl ether and lactic acid according to the above formulated amount at 60° C. and conducting heat-preservation under stirring for 3 h, then adding carbon black according to the above formulated amount, and grinding to obtain the color paste; and
(3) mixing the emulsion prepared in the step (1) with the color paste prepared in the step (2) according to the above ratio to obtain the flexible polymer electrophoretic coating.

A method for preparing a garden shear included the following steps:
1) demagnetizing a shear blank and hanging the same onto a hanger, to obtain a hanger product;
2) cleaning the hanger product by an ultrasonic wave to degrease and remove surface impurities;
3) introducing the hanger product into a coating tank containing a coating solution and soaking the hanger product in the coating solution at room temperature for 10 minutes, wherein the coating solution included the following raw materials in parts by weight: 40 parts of phosphoric acid; 20 parts of citric acid; 20 parts of zinc oxide; 4 parts of 2,3-dihydrobutanedioic acid; 2 parts of iron nitrate nonahydrate; 2 parts of nickel nitrate hexahydrate; and 30 parts of water;
4) passing the hanger product through a first showerhead for spraying with pure water for 4 minutes and 10 seconds;
5) introducing the hanger product into a pure water tank and soaking the hanger product in pure water for 1 minute and 20 seconds;
6) passing the hanger product through a second showerhead for spraying with pure water for 2 minutes and 48 seconds;
7) introducing the hanger product into an electrophoresis tank to undergo electrophoresis in the electrophoretic coating as described above, wherein the electrophoresis was conducted at a voltage of 120 V for a duration of 90 seconds;
8) passing the hanger product through a third showerhead and a fourth showerhead for spraying for a duration of 5 minutes and 51 seconds;
9) placing the hanger product into an oven for baking at a temperature of 270° C. for a duration of 40 minutes; and
10) removing the hanger product from the oven and passing the same through a cooling zone for cooling down to obtain the garden shear.

The aforementioned hanger product ran at a linear speed of 22 m/s, and the production processes were all operated under normal pressure.

### Example 3

A flexible polymer electrophoretic coating including an emulsion and a color paste was provided, wherein the emulsion included the following raw materials in parts by weight: 30.5 parts of an epoxy resin; 3 parts of monoethanolamine; 3.5 parts of propylene glycol methyl ether acetate; 0.5 parts of propylene glycol phenyl ether; 2.6 parts of lactic acid; and 59.9 parts of water; the color paste included the following raw materials in parts by weight: 7.5 parts of an epoxy resin; 0.5 parts of monoethanolamine; 2 parts of propylene glycol methyl ether acetate; 0.1 parts of propylene glycol phenyl ether; 1 part of lactic acid; and 0.5 parts of carbon black; and a weight ratio of the emulsion to the color paste was 1.5:1.

A method for preparing the aforementioned flexible polymer electrophoretic coating included the following steps:
(1) preparation of an emulsion: mixing an epoxy resin, monoethanolamine, propylene glycol methyl ether acetate, propylene glycol phenyl ether and lactic acid according to the above formulated amount at 65° C. and conducting heat-preservation under stirring for 2.5 h, and then adding water according to the above formulated amount and stirring for 1.5 h, to obtain the emulsion;
(2) preparation of a color paste: mixing an epoxy resin, monoethanolamine, propylene glycol methyl ether acetate, propylene glycol phenyl ether and lactic acid according to the above formulated amount at 55° C. and conducting heat-preservation under stirring for 2.5 h, then adding carbon black according to the above formulated amount, and grinding to obtain the color paste; and
(3) mixing the emulsion prepared in the step (1) with the color paste prepared in the step (2) according to the above ratio to obtain the flexible polymer electrophoretic coating.

A method for preparing a garden shear included the following steps:
1) demagnetizing a shear blank and hanging the same onto a hanger, to obtain a hanger product;
2) cleaning the hanger product by an ultrasonic wave to degrease and remove surface impurities;
3) introducing the hanger product into a coating tank containing a coating solution and soaking the hanger product in the coating solution at room temperature for 7 minutes, wherein the coating solution included the following raw materials in parts by weight: 35 parts of phosphoric acid; 15 parts of citric acid; 15 parts of zinc oxide; 3.2 parts of 2,3-dihydrobutanedioic acid; 1.8 parts of iron nitrate nonahydrate; 1.8 parts of nickel nitrate hexahydrate; and 28.2 parts of water;
4) passing the hanger product through a first showerhead for spraying with pure water for 4 minutes and 10 seconds;
5) introducing the hanger product into a pure water tank and soaking the hanger product in pure water for 1 minute and 20 seconds;
6) passing the hanger product through a second showerhead for spraying with pure water for 2 minutes and 48 seconds;
7) introducing the hanger product into an electrophoresis tank to undergo electrophoresis in the electrophoretic coating as described above, wherein the electrophoresis was conducted at a voltage of 100 V for a duration of 80 seconds;
8) passing the hanger product through a third showerhead and a fourth showerhead for spraying for a duration of 5 minutes and 51 seconds;
9) placing the hanger product into an oven for baking at a temperature of 265° C. for a duration of 35 minutes; and
10) removing the hanger product from the oven and passing the same through a cooling zone for cooling down to obtain the garden shear.

The aforementioned hanger product ran at a linear speed of 22 m/s, and the production processes were all operated under normal pressure.

### Example 4

A flexible polymer electrophoretic coating including an emulsion and a color paste was provided, wherein the emulsion included the following raw materials in parts by weight: 35 parts of an epoxy resin; 4 parts of monoethanolamine; 3 parts of propylene glycol methyl ether acetate; 0.6 parts of propylene glycol phenyl ether; 2.5 parts of lactic acid; and 60 parts of water; the color paste included the following raw materials in parts by weight: 6 parts of an epoxy resin; 0.6 parts of monoethanolamine; 2.5 parts of propylene glycol methyl ether acetate; 0.2 parts of propylene glycol phenyl ether; 1.5 parts of lactic acid; and 0.3 parts of carbon black; and a weight ratio of the emulsion to the color paste was 1:1.

A method for preparing the aforementioned flexible polymer electrophoretic coating included the following steps:
(1) preparation of an emulsion: mixing an epoxy resin, monoethanolamine, propylene glycol methyl ether acetate, propylene glycol phenyl ether and lactic acid according to the above formulated amount at 65° C. and conducting heat-preservation under stirring for 2.5 h, and then adding water according to the above formulated amount and stirring for 1.5 h, to obtain the emulsion;
(2) preparation of a color paste: mixing an epoxy resin, monoethanolamine, propylene glycol methyl ether acetate, propylene glycol phenyl ether and lactic acid according to the above formulated amount at 55° C. and conducting heat-preservation under stirring for 2.5 h, then adding carbon black according to the above formulated amount, and grinding to obtain the color paste; and
(3) mixing the emulsion prepared in the step (1) with the color paste prepared in the step (2) according to the above ratio to obtain the flexible polymer electrophoretic coating.

A method for preparing a garden shear included the following steps:
1) demagnetizing a shear blank and hanging the same onto a hanger, to obtain a hanger product;
2) cleaning the hanger product by an ultrasonic wave to degrease and remove surface impurities;
3) introducing the hanger product into a coating tank containing a coating solution and soaking the hanger product in the coating solution at room temperature for 7 minutes, wherein the coating solution included the following raw materials in parts by weight: 35 parts of phosphoric acid; 15 parts of citric acid; 15 parts of zinc oxide; 3.2 parts of 2,3-dihydrobutanedioic acid; 1.8 parts of iron nitrate nonahydrate; 1.8 parts of nickel nitrate hexahydrate; and 28.2 parts of water;
4) passing the hanger product through a first showerhead for spraying with pure water for 4 minutes and 10 seconds;
5) introducing the hanger product into a pure water tank and soaking the hanger product in pure water for 1 minute and 20 seconds;
6) passing the hanger product through a second showerhead for spraying with pure water for 2 minutes and 48 seconds;
7) introducing the hanger product into an electrophoresis tank to undergo electrophoresis in the electrophoretic coating as described above, wherein the electrophoresis was conducted at a voltage of 100 V for a duration of 80 seconds;
8) passing the hanger product through a third showerhead and a fourth showerhead for spraying for a duration of 5 minutes and 51 seconds;
9) placing the hanger product into an oven for baking at a temperature of 265° C. for a duration of 35 minutes; and
10) removing the hanger product from the oven and passing the same through a cooling zone for cooling down to obtain the garden shear.

The aforementioned hanger product ran at a linear speed of 22 m/s, and the production processes were all operated under normal pressure.

### Example 5

A flexible polymer electrophoretic coating including an emulsion and a color paste was provided, wherein the emulsion included the following raw materials in parts by weight: 25 parts of an epoxy resin; 2 parts of monoethanolamine; 2 parts of propylene glycol methyl ether acetate; 0.3 parts of propylene glycol phenyl ether; 2.2 parts of lactic acid; and 55 parts of water; the color paste included the following raw materials in parts by weight: 7 parts of an epoxy resin; 0.3 parts of monoethanolamine; 2.2 parts of propylene glycol methyl ether acetate; 0.25 parts of propylene glycol phenyl ether; 1.3 parts of lactic acid; and 0.6 parts of carbon black; and a weight ratio of the emulsion to the color paste was 1.2:1.

A method for preparing the aforementioned flexible polymer electrophoretic coating included the following steps:
(1) preparation of an emulsion: mixing an epoxy resin, monoethanolamine, propylene glycol methyl ether acetate, propylene glycol phenyl ether and lactic acid according to the above formulated amount at 65° C. and conducting heat-preservation under stirring for 2.5 h, and then adding water according to the above formulated amount and stirring for 1.5 h, to obtain the emulsion;
(2) preparation of a color paste: mixing an epoxy resin, monoethanolamine, propylene glycol methyl ether acetate, propylene glycol phenyl ether and lactic acid according to the above formulated amount at 55° C. and conducting heat-preservation under stirring for 2.5 h, then adding carbon black according to the above formulated amount, and grinding to obtain the color paste; and
(3) mixing the emulsion prepared in the step (1) with the color paste prepared in the step (2) according to the above ratio to obtain the flexible polymer electrophoretic coating.

A method for preparing a garden shear included the following steps:
1) demagnetizing a shear blank and hanging the same onto a hanger, to obtain a hanger product;
2) cleaning the hanger product by an ultrasonic wave to degrease and remove surface impurities;
3) introducing the hanger product into a coating tank containing a coating solution and soaking the hanger product in the coating solution at room temperature for 7 minutes, wherein the coating solution included the following raw materials in parts by weight: 35 parts of phosphoric acid; 15 parts of citric acid; 15 parts of zinc oxide; 3.2 parts of 2,3-dihydrobutanedioic acid; 1.8 parts of iron nitrate nonahydrate; 1.8 parts of nickel nitrate hexahydrate; and 28.2 parts of water;
4) passing the hanger product through a first showerhead for spraying with pure water for 4 minutes and 10 seconds;
5) introducing the hanger product into a pure water tank and soaking the hanger product in pure water for 1 minute and 20 seconds;
6) passing the hanger product through a second showerhead for spraying with pure water for 2 minutes and 48 seconds;
7) introducing the hanger product into an electrophoresis tank to undergo electrophoresis in the electrophoretic coating as described above, wherein the electrophoresis was conducted at a voltage of 100 V for a duration of 80 seconds;
8) further passing the hanger product through a third showerhead and a fourth showerhead for spraying for a duration of 5 minutes and 51 seconds;
9) placing the hanger product into an oven for baking at a temperature of 265° C. for a duration of 35 minutes; and
10) removing the hanger product from the oven and passing the same through a cooling zone for cooling down to obtain the garden shear.

The aforementioned hanger product ran at a linear speed of 22 m/s, and the production processes were all operated under normal pressure.

### Comparative Example 1

A commercially available garden shear coated with a waterborne Teflon coating was provided.

### Test Example:

1. The garden shears of Examples 1-5 and Comparative Example 1 were respectively used for simulating daily shearing and were tested by a shear force tester. A beech branch of about 10 mm was used as a material to be sheared. A shearing speed was adjusted such that the beech branch was cut with a maximum shearing force of 35-40 kgf each time. The paint film on the surface of the shears was observed after the shears had conducted shearing for 3,000 times. The testing results are shown in Table 1.

TABLE 1
Surface abrasion of the shears

| | Condition of paint film |
|---|---|
| Example 1 | complete paint film without |
| | peeling |
| Example 2 | complete paint film without |
| | peeling |
| Example 3 | complete paint film without |
| | peeling |
| Example 4 | complete paint film without |
| | peeling |
| Example 5 | complete paint film without |
| | peeling |
| Comparative | abrased paint film with obvious |
| Example 1 | peeling |

2. The garden shears of Examples 1-5 were subjected to a salt spray resistance test and an adhesion test respectively, and the test results are shown in Table 2.

TABLE 2
Results of salt spray resistance test and adhesion test

| | Salt spray resistance | |
|---|---|---|
| | test (5% sodium | |
| | chloride) | Adhesion grade |
| Example | ≥200H | Level 2 |
| 1 | | |
| Example | ≥200H | Level 2 |
| 2 | | |
| Example | ≥200H | Level 1 |
| 3 | | |
| Example | ≥200H | Level 2 |
| 4 | | |
| Example | ≥200H | Level 2 |
| 5 | | |

The above embodiments are preferred embodiments of the present disclosure. However, the implementations of the present disclosure are not limited by the above embodiments. Any other equivalent changes, modifications, substitutions, combinations, and simplifications may be made without departing from the protection scope and principle of the present disclosure, which are all included in the scope of the present disclosure.

1. A flexible polymer electrophoretic coating, comprising an emulsion and a color paste;
wherein the emulsion comprises the following raw materials in parts by weight:
20-40 parts of an epoxy resin;
1-5 parts of ethanolamine;
1-5 parts of propylene glycol methyl ether acetate;
0.1-1 parts of propylene glycol phenyl ether;
2-3 parts of lactic acid; and
50-70 parts of water; and
the color paste comprises the following raw materials in parts by weight:
5-10 parts of an epoxy resin;
0.1-1 parts of ethanolamine;
1-3 parts of propylene glycol methyl ether acetate;
0.05-0.3 parts of propylene glycol phenyl ether;
0.5-2 parts of lactic acid; and
0.1-1 parts of a colorant; and
a weight ratio of the emulsion to the color paste is (1-2):1.

2. The flexible polymer electrophoretic coating of claim 1, wherein the ethanolamine is monoethanolamine.

3. The flexible polymer electrophoretic coating of claim 1, wherein the colorant is carbon black.

4. A method for preparing the flexible polymer electrophoretic coating of claim 1, comprising the following steps:
(1) preparation of an emulsion: mixing an epoxy resin, ethanolamine, propylene glycol methyl ether acetate, propylene glycol phenyl ether and lactic acid at a formulated amount at 60-70° C. and conducting heat-preservation under stirring for 2-3 h, and then adding a formulated amount of water and stirring for 1-2 h, to obtain the emulsion;
(2) preparation of a color paste: mixing an epoxy resin, ethanolamine, propylene glycol methyl ether acetate, propylene glycol phenyl ether and lactic acid at a formulated amount at 50-60° C. and conducting heat-preservation under stirring for 2-3 h, then adding a formulated amount of a colorant, and grinding to obtain the color paste; and
(3) mixing the emulsion prepared in the step (1) with the color paste prepared in the step (2) in proportion to obtain the flexible polymer electrophoretic coating.

5. A method for preparing a garden shear, comprising the following steps:
(1) demagnetizing and cleaning a shear blank;
(2) subjecting the shear obtained in the step (1) to electrophoretic painting, wherein an electrophoretic coating used in the electrophoretic painting comprises the flexible polymer electrophoretic coating of claim 1; and
(3) cleaning the shear obtained in the step (2), and then baking and cooling to obtain a finished garden shear.

6. The method for preparing the garden shear of claim 5, wherein the shear obtained in the step (1) is subjected to soaking treatment in a coating solution before the electrophoretic painting, and the coating solution comprises the following raw materials in parts by weight:
30-40 parts of phosphoric acid;
10-20 parts of citric acid;
10-20 parts of zinc oxide;
3-4 parts of 2,3-dihydrobutanedioic acid;
1-2 parts of iron nitrate nonahydrate;
1-2 parts of nickel nitrate hexahydrate; and
25-30 parts of water.

7. The method for preparing the garden shear of claim 6, wherein the soaking treatment is conducted in the coating solution for 5-10 minutes.

8. The method for preparing the garden shear of claim 5, wherein in the step (2), the electrophoretic painting is conducted at a voltage of 100-120 V and a temperature of 15-35° C.

9. The method for preparing the garden shear of claim 5, wherein in the step (2), the electrophoretic painting is conducted for 60-90 seconds.

10. The method for preparing the garden shear of claim 5, wherein in the step (3), the baking is conducted at a temperature of 260-270° C. for a duration of 30-40 min.
